(19) United States
(12) Patent Application Publication
(10) Pub. No.: US 2013/0345501 A1
(43) Pub. Date: Dec. 26, 2013

(54) Sexual Aid Device

(71) Applicant: Timothy O'Reilly, Ansonia, CT (US)

(72) Inventor: Timothy O'Reilly, Ansonia, CT (US)

(21) Appl. No.: 13/917,276

(22) Filed: Jun. 13, 2013

Related U.S. Application Data
(60) Provisional application No. 61/659,161, filed on Jun. 13, 2012.

(51) Int. Cl. A61H 19/00

(52) U.S. Cl. CPC A61H 19/44
USPC 600/38

(57) ABSTRACT

A sexual aid device comprising: a generally cylindrically shaped shaft; a set of shaft threads on the first end of the shaft; a first head attached to the second end of the shaft; a plurality of inserts configured to slide along the shaft and configured to not be able to slide over the first head; and a second head with a set of internal threads configured to mate with the shaft threads, wherein when the second head is attached to the second end of the shaft, any inserts located on the shaft are held in place on the shaft by the first and second heads.

### CROSS-REFERENCES

This patent application claims the benefit of provisional patent application no. 61/659,161 to Timothy O'Reilly, entitled “Sexual Aid Device”, filed on Jun. 13, 2012, and which provisional application is fully incorporated by reference herein.

### TECHNICAL FIELD

The present invention relates to a sexual aid device, and more specifically to a sexual aid device such as a dildo that can be easily modified.

### BACKGROUND

People often search for and purchase a sexual aid device such as a dildo or vibrator that they think will work well for them. It may be studded, ribbed, have various protrusions for stimulation and so on. It may be made of plastic, rubber, metal, etc. It may vibrate, shake, spin, etc. In all these cases, the customer will decide what he or she wants, and selects a product that may have some of the desired features. They may need to buy multiple products to get the device that they eventually want after some trial and error. After some time, he or she may become bored of the device and want something different. This starts the whole process over again and new products need to be purchased. There are currently no known dildoes or vibrators on the market that are re-configurable or upgradable.

Thus there is a need for a sexual aid device that can be easily and quickly modified and that can overcome the above listed and other disadvantages.

### SUMMARY OF THE INVENTION

The disclosed invention relates to a sexual aid device comprising: a generally cylindrically shaped shaft; a set of shaft threads on the first end of the shaft; a first head attached to the second end of the shaft; a plurality of inserts configured to slide along the shaft and configured to not be able to slide over the first head; and a second head with a set of internal threads configured to mate with the shaft threads, wherein when the second head is attached to the second end of the shaft, any inserts located on the shaft are held in place on the shaft by the first and second heads.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is an exploded view of the sexual aid device;

FIG. 2 is an assembled view of one embodiment of the sexual aid device;

FIG. 3 is a close up view of the first head and shaft;

FIGS. 4-6 show several views of the end head;

FIGS. 7-9 show several views of the knobbed insert;

FIGS. 10-12 show several views of the helix insert;

FIG. 13-15 show several views of the ribbed insert;

FIGS. 16-18 show several views of the French tickler insert;

FIGS. 19-21 show several views of the holey insert;

FIGS. 22-24 show several views of the cube insert;

FIGS. 25-27 shows several views of the bump insert;

FIGS. 28-30 show several views of a smaller rib insert;

FIGS. 31-33 show several views of a smaller knobbed insert;

FIGS. 34-36 show several views of another embodiment of the helix insert;

FIG. 37 shows an exploded view of a smaller embodiment of the disclosed sexual aid device;

FIG. 38 shows the assembled sexual aid device from FIG. 37;

FIG. 39 shows the sexual aid device just the small ball;

FIG. 40 shows the sexual aid device using just the large ball inserts;

FIG. 41 shows the sexual aid device using just the medium ball inserts;

FIGS. 42-43 show two views of the first small head;

FIGS. 44-45 shows two views of the large ball insert;

FIGS. 46-47 show two views of the medium ball insert;

FIGS. 48-49 show two views of the small ball insert;

FIG. 50 shows a cross-sectional view of another embodiment of end head; and

FIG. 51 shows another cross-sectional view of the end head from FIG. 50.

### DETAILED DESCRIPTION

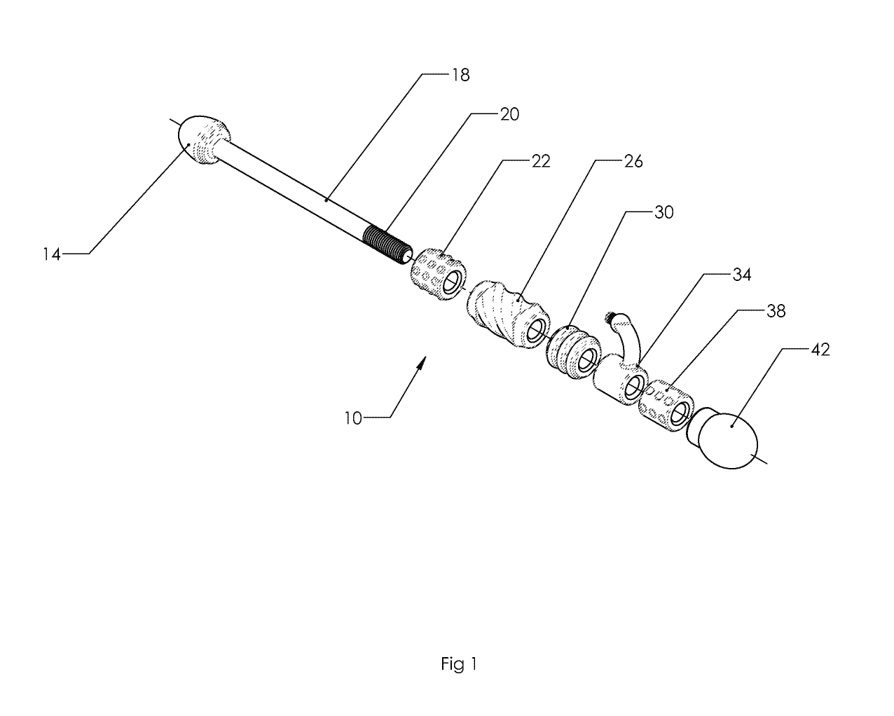

FIG. 1 shows an exploded view of the sexual aid device 10. Comprising the device is a first head 14. Attached to the first head is a shaft 18 with threads 20 on an end away from the first head of the shaft 18. The first head 14 has a generally bulbous shape or generally spheroidal shape to generally look like and shaped like the head of a penis. However, the head 14 may comprise different shapes such as but not limited to a spherical shape, fist shaped, a narrow cylindrical shape, etc. Various inserts 22, 26, 30, 34, 38 are slideable over the threads 20 and over the shaft 18, but are not slideable over the first head 14. The various inserts may be of any suitable size, including but not limited to an outer diameter of about 4″ to about 1″. An end head 42 has internal threads configured to mate with the threads 20. In one embodiment, the first head 14 may be permanently attached to the shaft 18. In another embodiment, the first head 14 may be removeably attachable to the shaft 18 via a threaded connection. In one embodiment, the outer diameter of the first head and end head may be about 3″ to about 1″, and the outer diameter of the shaft 18 may be about 0.5″ to about 2″.

FIG. 2 shows one embodiment of the assembled sexual aid device 10 from FIG. 1. One will recognize that the order of the inserts can be changed, currently the inserts are ordered as follows: 22, 26, 30, 34, 38. The inserts may be arranged in a different order, to whatever arrangement suits the user. Additionally, the inserts used in FIG. 2, may be replaced with other inserts or spacers.

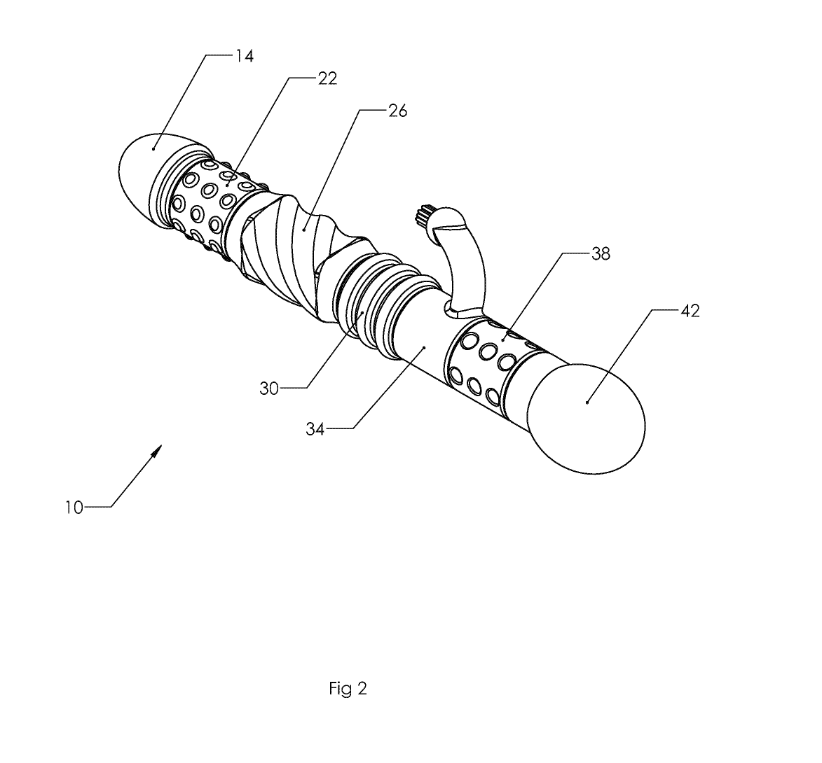

FIG. 3 shows a close-up view of the first head and shaft 18 with threads 20.

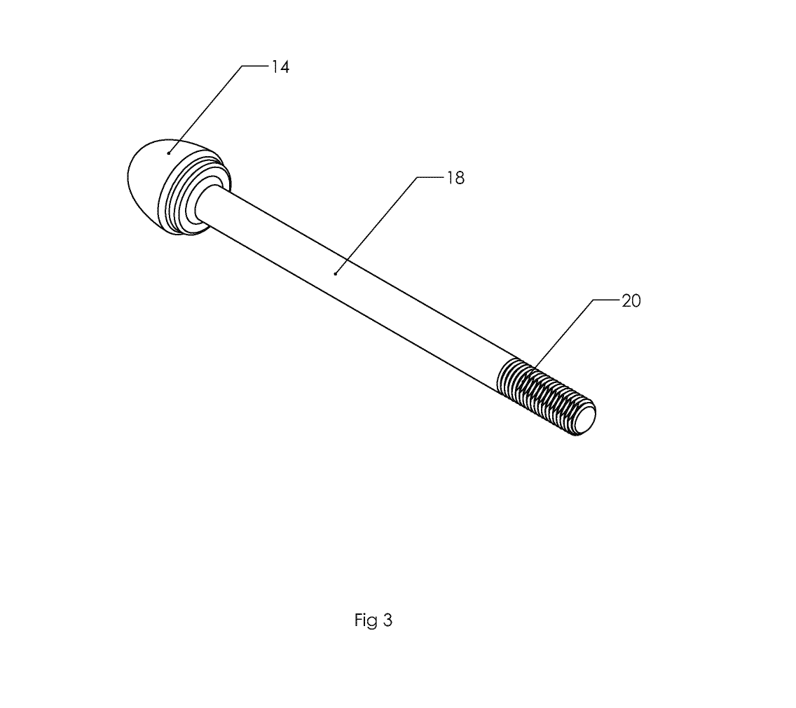

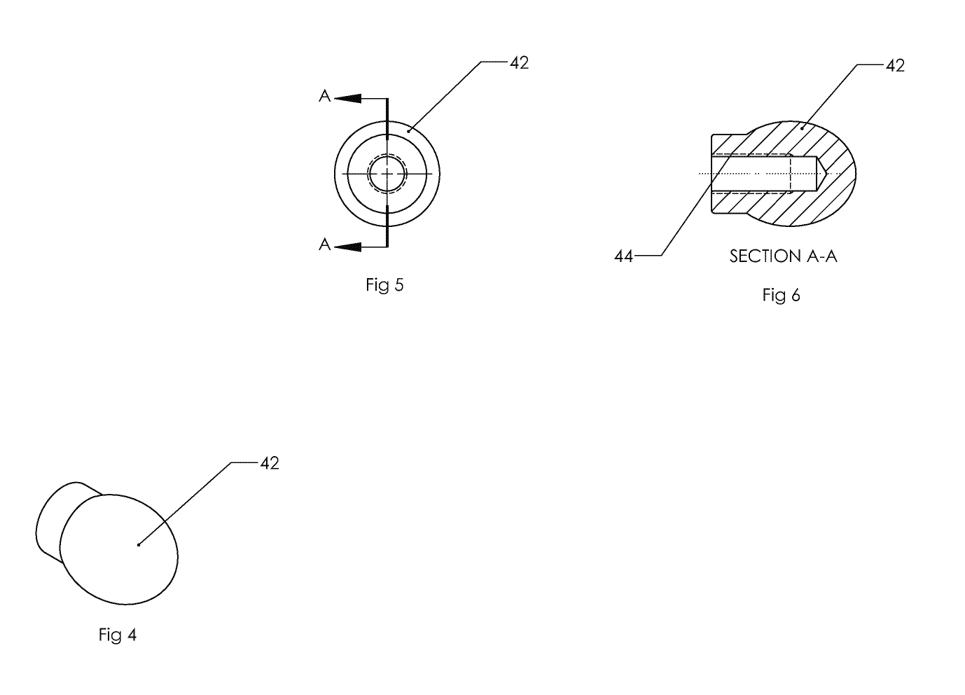

FIGS. 4-6 show several views of the end head 42. In the side view shown at FIG. 6, the threads 44 internal to the first head 42 are shown. In another embodiment, the end head 42 may have a vibrating motor inside of it to provide a vibration component to the device.

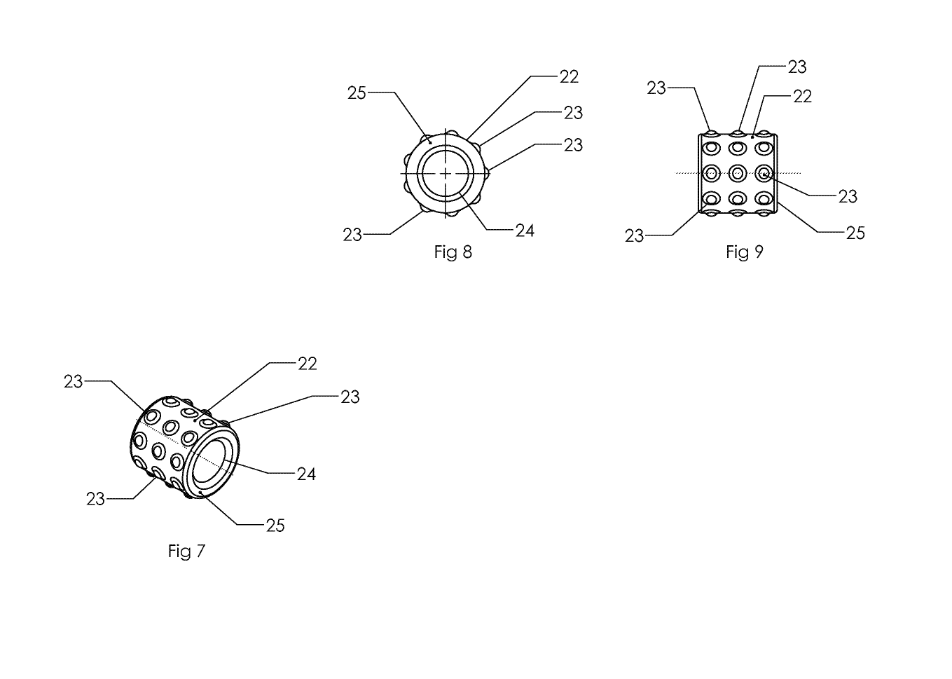

FIGS. 7-9 show several views of the knobbed insert 22. The knobbed insert 22 comprises a collar 25. Knobbed insert 22 has a plurality of knobs 23 or protrusions on the outer surface of the collar 25. In addition, the insert has an opening 24 that extends through the length of the insert, that allows the insert 22 to slide over the threads 22 and the shaft 18. However, the opening 24 is not so large that it can slide over the first head 14 and end head 42. In one embodiment, the knobs 23 may extend from the surface of the insert 22 by about 0.4″ to about 0.1″.

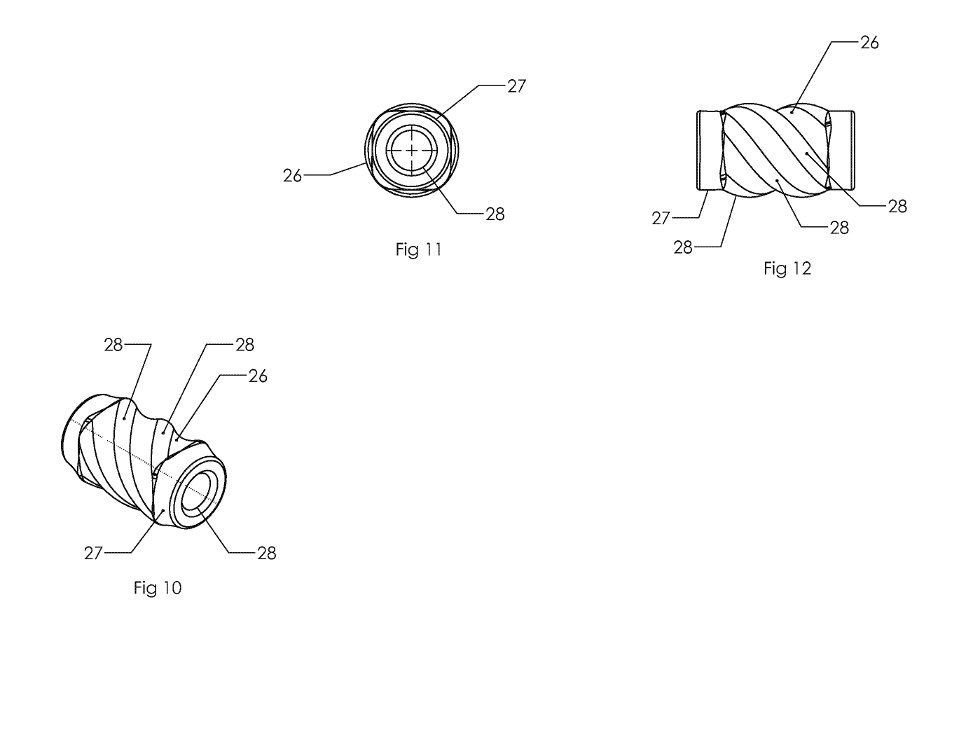

FIGS. 10-12 show several views of the helix insert 26. The helix insert 26 comprises a collar 27 with an outer surface characterized by several helices 28 that traverse most of the length of the insert 26. The insert 26 also has an opening 28 that extends through the length of the insert, that allows the insert 26 to slide over the threads 22 and the shaft 18. However, the opening 28 is not so large that it can slide over the first head 14 and end head 42.

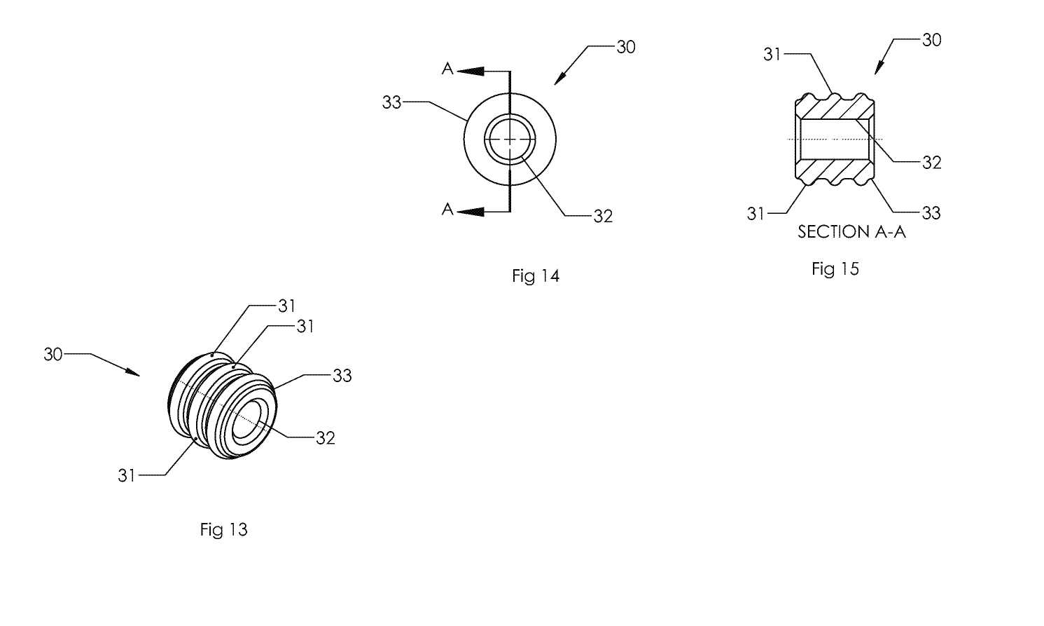

FIGS. 13-15 show several views of the ribbed insert 30. The ribbed insert 30 comprises a collar 33. There are a plurality of ribs 31 extending generally orthogonally from the outer surface of the collar 33, and in this embodiment, three (3) ribs. The insert 30 also has an opening 32 that extends through the length of the insert, that allows the insert 30 to slide over the threads 22 and the shaft 18. However, the opening 30 is not so large that it can slide over the first head 14 and end head 42. The ribs 31 may extend from the surface of the insert 30 by about 0.4″ to about 0.1″.

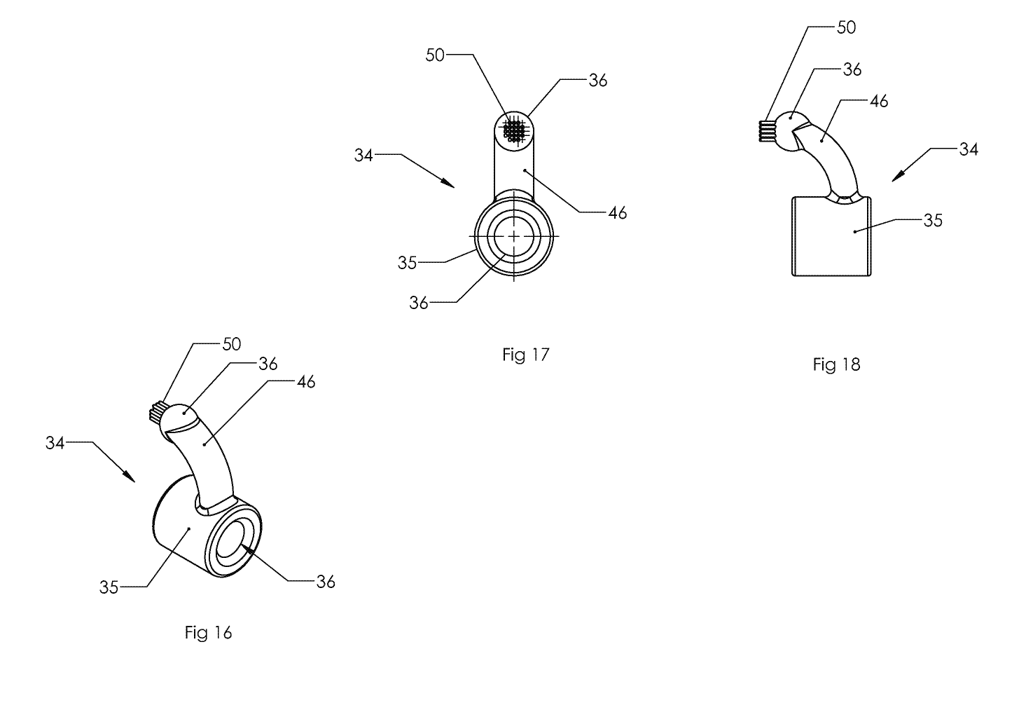

FIGS. 16-18 show several views of a French tickler insert 34. This insert 34 has a collar member 35 with an extending member 46 extending from the collar member 35. There may be hair like protrusions 50 emanating from a spherical member 36 on the distal end of the extending member 46. The insert 34 also has an opening 36 that extends through the length of the insert, that allows the insert 34 to slide over the threads 22 and the shaft 18. However, the opening 36 is not so large that it can slide over the first head 14 and end head 42. In one embodiment, the extending member 46 and spherical member 36 may extend about 3″ to about 1″ from the surface of the collar member 35. In one embodiment, the hair like protrusions 50 may extend about 0.1″ to about 0.6″ from the surface of the spherical member 36.

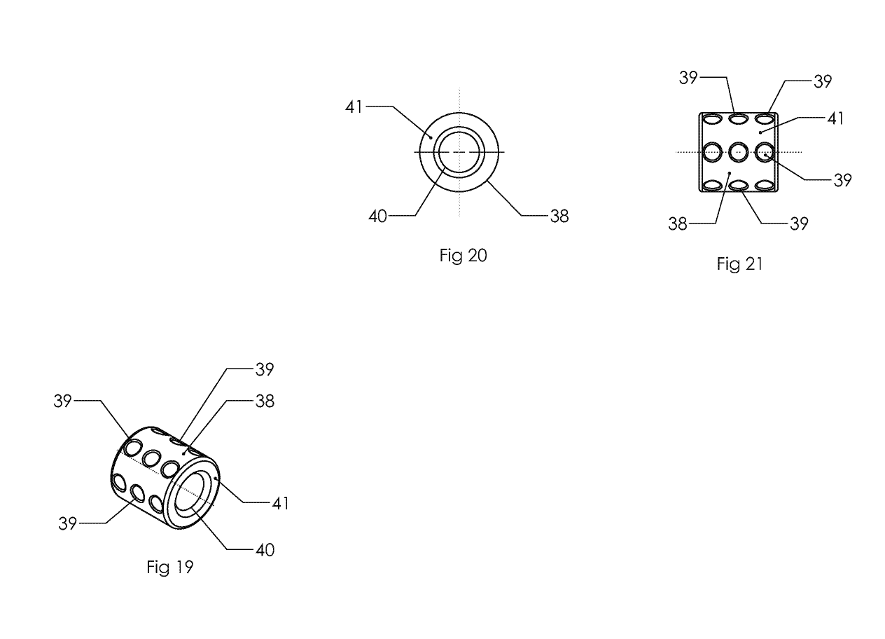

FIGS. 19-21 show several views of the holey insert 38. The holey insert 38 comprises a collar 41 which has a plurality of holes 39 in the surface of the collar 41. The insert 38 also has an opening 40 that extends through the length of the insert, that allows the insert 38 to slide over the threads 22 and the shaft 18. However, the opening 40 is not so large that it can slide over the first head 14 and end head 42. The diameter of the holes may range from about 0.1″ to about 0.6″.

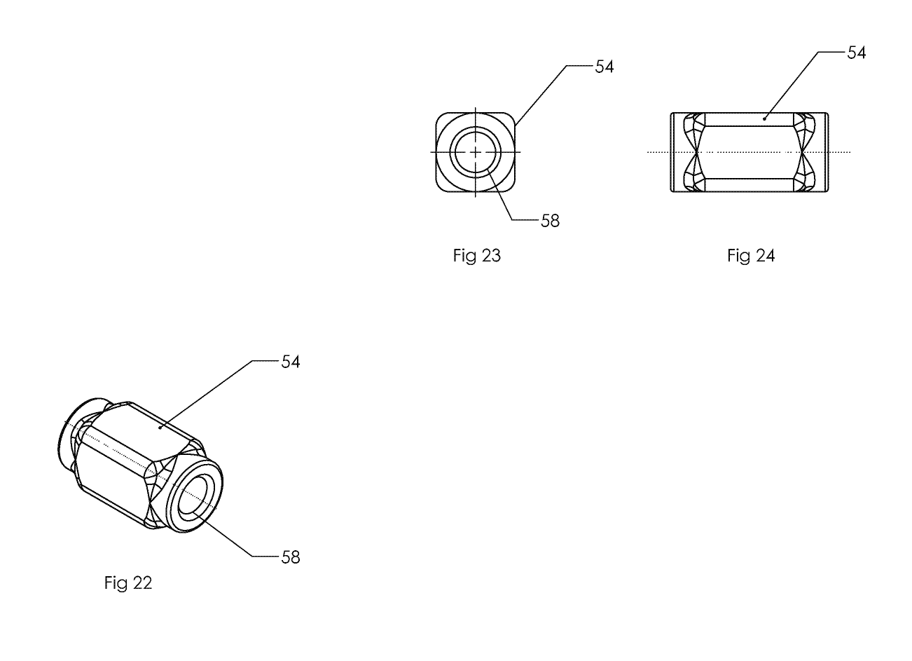

FIGS. 22-24 show several views of an insert 54 that was not shown in FIGS. 1 and 2. This cube insert has generally a cube shape outer surface with rounded corners. The insert 54 also has an opening 58 that extends through the length of the insert, that allows the insert 54 to slide over the threads 22 and the shaft 18. However, the opening 58 is not so large that it can slide over the first head 14 and end head 42.

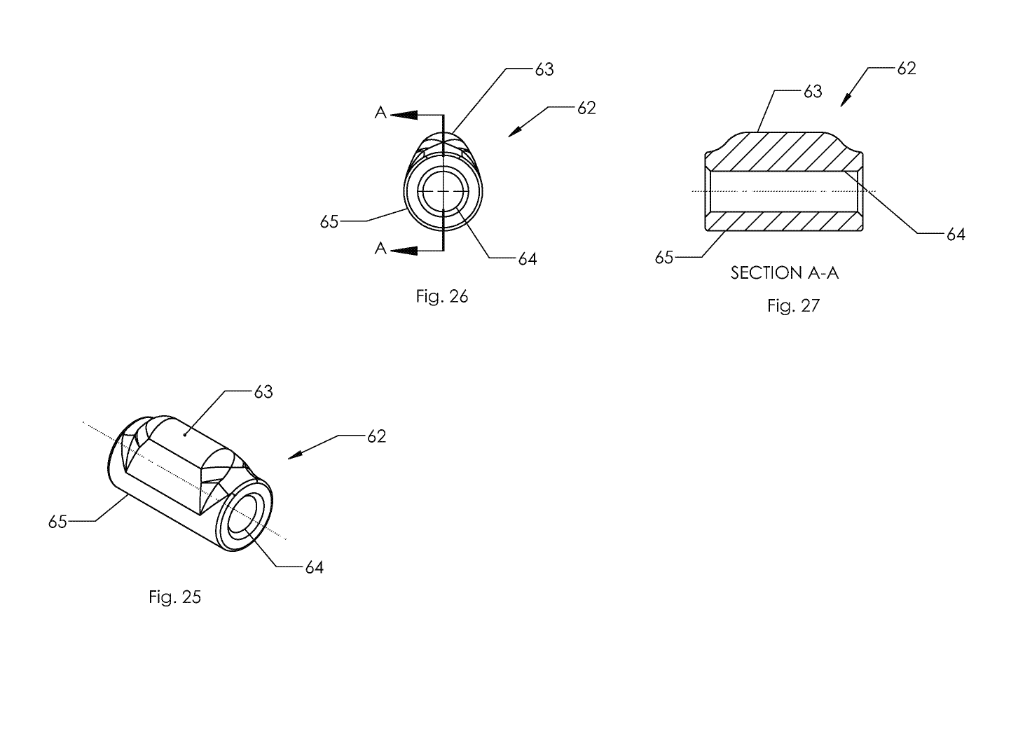

FIGS. 25-27 show several views of an insert 62 that was not shown in FIGS. 1 and 2. This insert comprises a cylindrically shaped bump collar 65 with a single generally large bump 63 protruding generally from no more than one half of the cylinder of the bump collar 65. The bump 63 may extend an additional 0.1″ to about 0.6″ from the cylindrical outer surface of the collar 65. The insert 62 also has an opening 64 that extends through the length of the insert, that allows the insert 62 to slide over the threads 22 and the shaft 18. However, the opening 64 is not so large that it can slide over the first head 14 and end head 42.

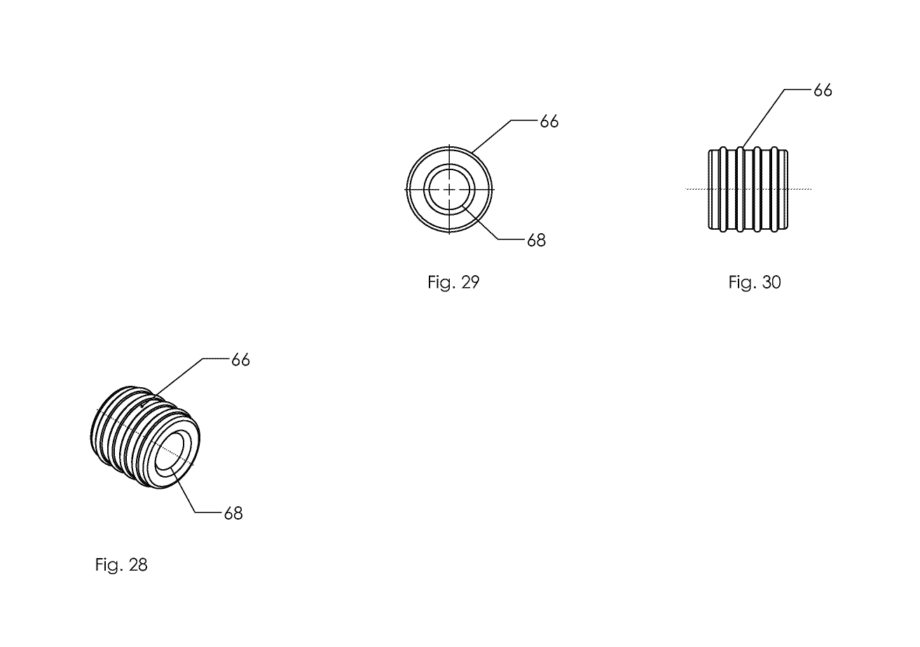

FIGS. 28-30 show several views of an insert 66 with smaller ribs than the insert 30 shown in FIG. 7. The insert 66 also has an opening 68 that extends through the length of the insert, that allows the insert 66 to slide over the threads 22 and the shaft 18. However, the opening 68 is not so large that it can slide over the first head 14 and end head 42.

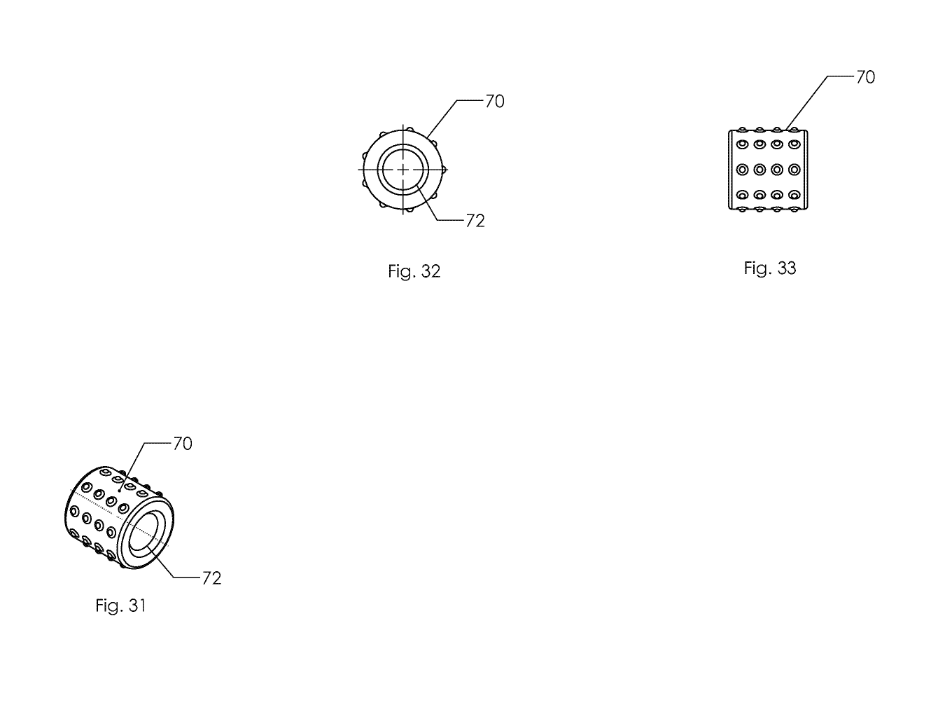

FIGS. 31-33 show several views of a knobbed insert 70 with smaller knobs than the insert 22 shown in FIG. 5. In addition, the insert has an opening 72 that extends through the length of the insert, that allows the insert 70 to slide over the threads 22 and the shaft 18. However, the opening 72 is not so large that it can slide over the first head 14 and end head 42.

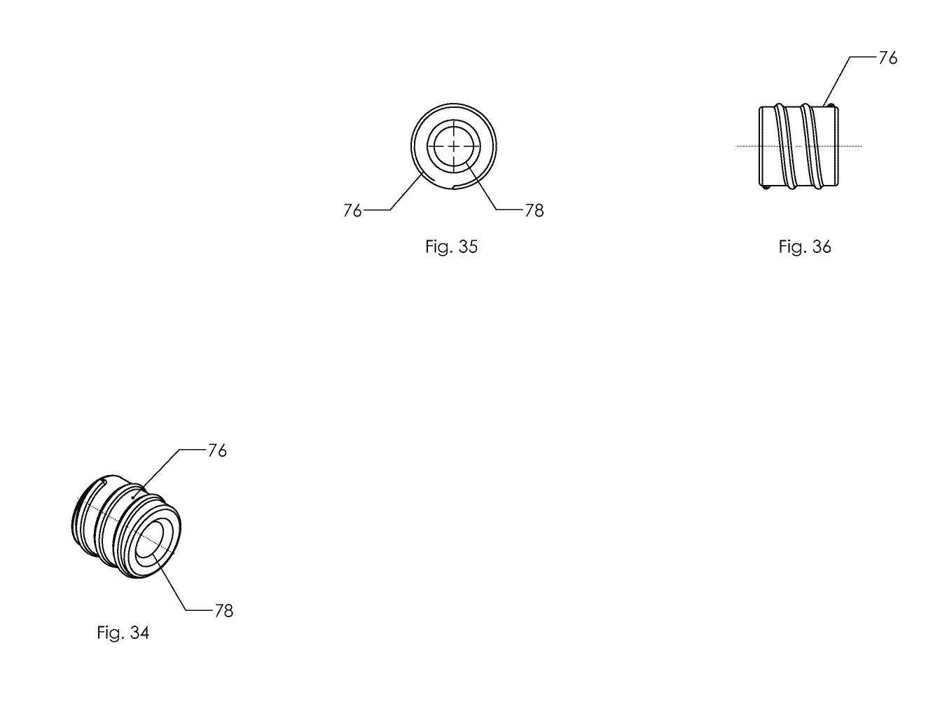

FIGS. 34-36 show several views of an insert 76 with a tighter helix than the insert 26 shown in FIG. 6. In addition, the insert has an opening 78 that extends through the length of the insert, that allows the insert 76 to slide over the threads 22 and the shaft 18. However, the opening 78 is not so large that it can slide over the first head 14 and end head 42.

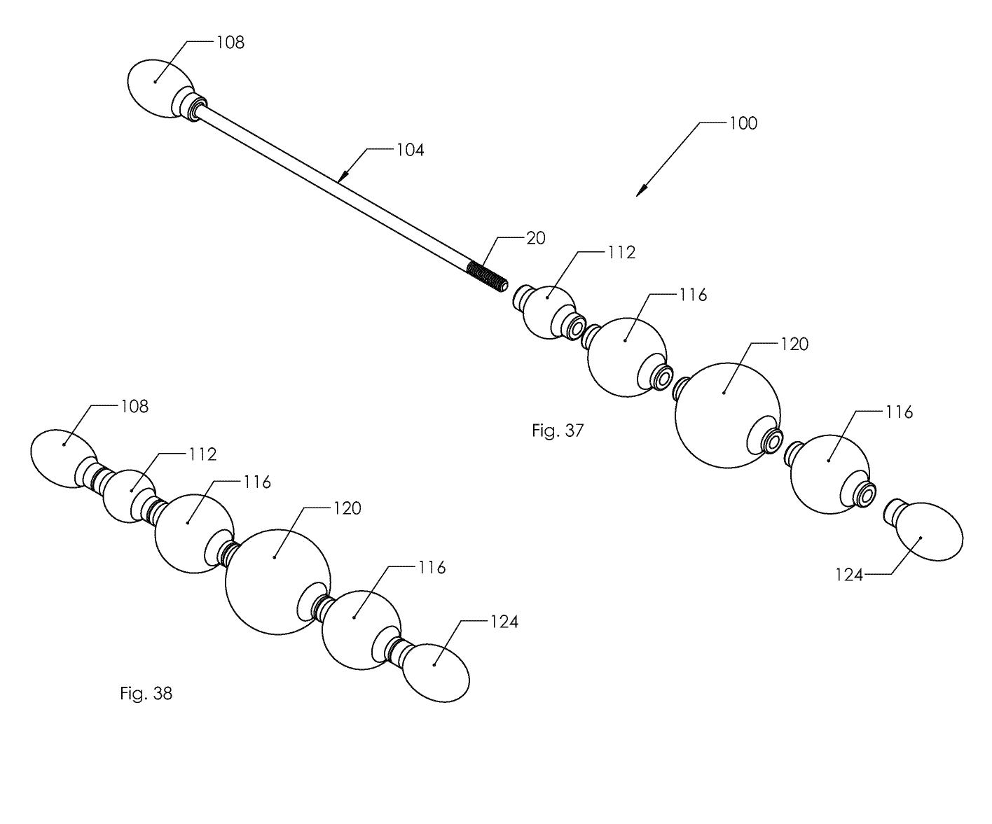

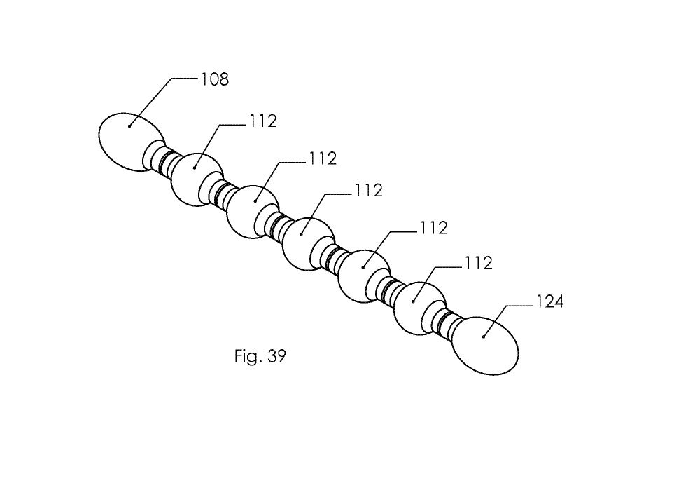

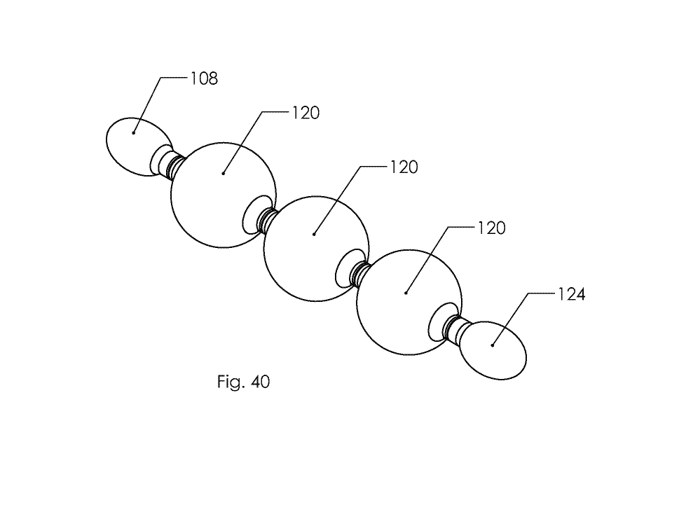

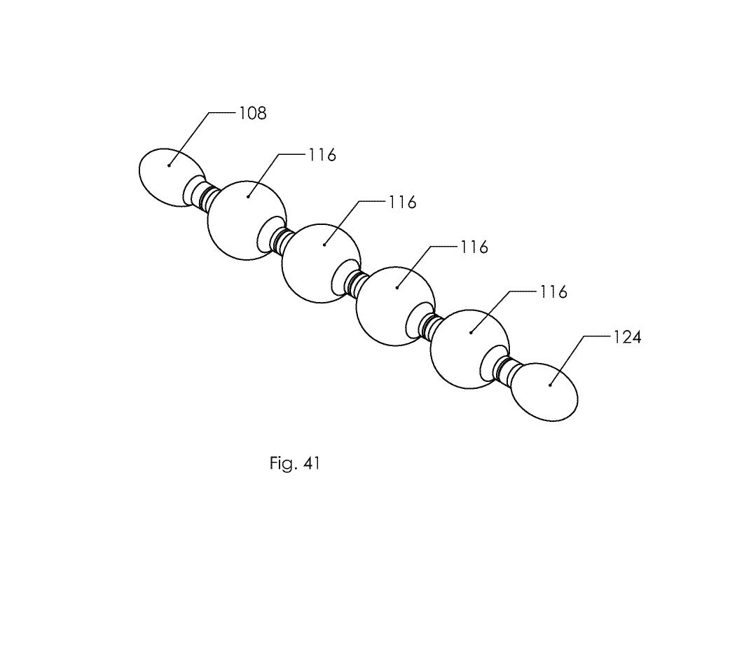

FIG. 37 shows another embodiment of the disclosed sexual aid device 100. In this view, the sexual aid device 100 is in an exploded view. The disclosed sexual aid device 100 is generally smaller than the device 10, and may be more suitable for use with smaller adults, or with the anus (as opposed to the vagina). The shaft 104 is generally of a smaller outer diameter than shaft 18. Attached to the shaft 104 is a first small head 108. The small head 108 may have generally a smaller outer diameter than first head 14. The first small head 108 has a generally bulbous shape to generally look like and shaped like the head of a penis. However, the head 108 may comprise different shapes such as but not limited to a spherical shape, fist shaped a narrow cylindrical shape, etc. Various inserts 112, 116, 120 are slideable over the threads 20 and over the shaft 104, but are not slideable over the first small head 108. A small end head 124 has internal threads configured to mate with the threads 20. In one embodiment, the first small head 108 may be permanently attached to the shaft 104. In another embodiment, the first small head 108 may be removeably attachable to the shaft 104 via a threaded connection. FIG. 38 shows the assembled sexual aid device 100. Although FIG. 37 and FIG. 38 shows various sized inserts 112, 116, 120, in other embodiments the inserts may be all of the same size, or may be varied in any way desired by the end user. FIG. 39 shows the sexual aid device 100 using just the small ball 112 inserts. FIG. 40 shows the sexual aid device 100 using just the large ball 120 inserts. FIG. 41 shows the sexual aid device 100 using just the medium ball 116 inserts. In one embodiment, the first small head 108 and small end head 124 may have out diameter of about 0.5″ to about 2″, and the shaft 104 may have an outer diameter of about 0.1″ to about 0.4″.

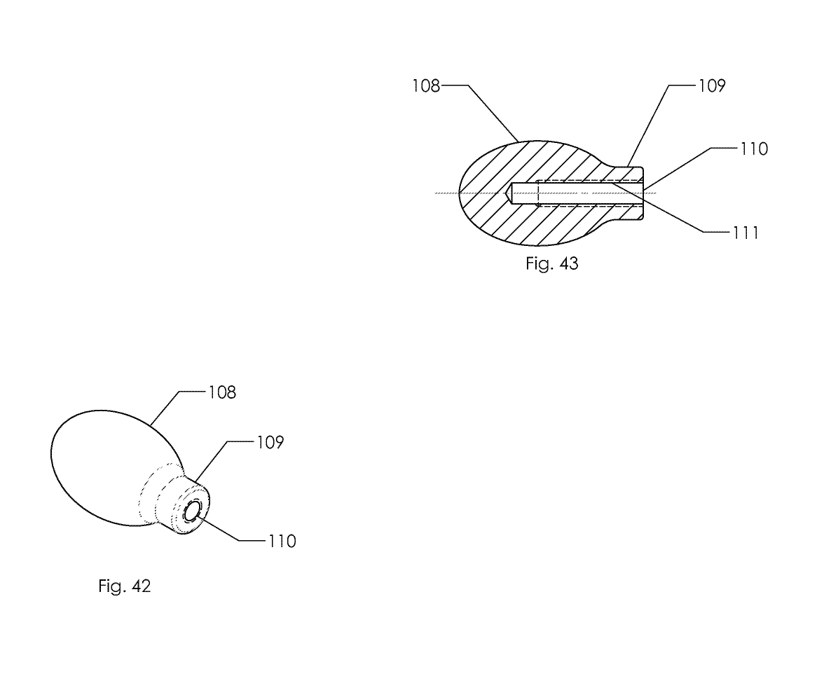

FIG. 42 shows a perspective view of the first small head 108. The shape of the first small head 108 may be generally spheroid. The small head 108 may have a generally cylindrically shaped spacer section 109 with an opening 110 to connect with the shaft 104. The spacer section 109 may help in separating other inserts that may be used with the device 100. FIG. 43 is a cross-sectional view of the first small head 108. In one embodiment, the small first head 108 may have threads 111 that can screw onto threads on the shaft 104.

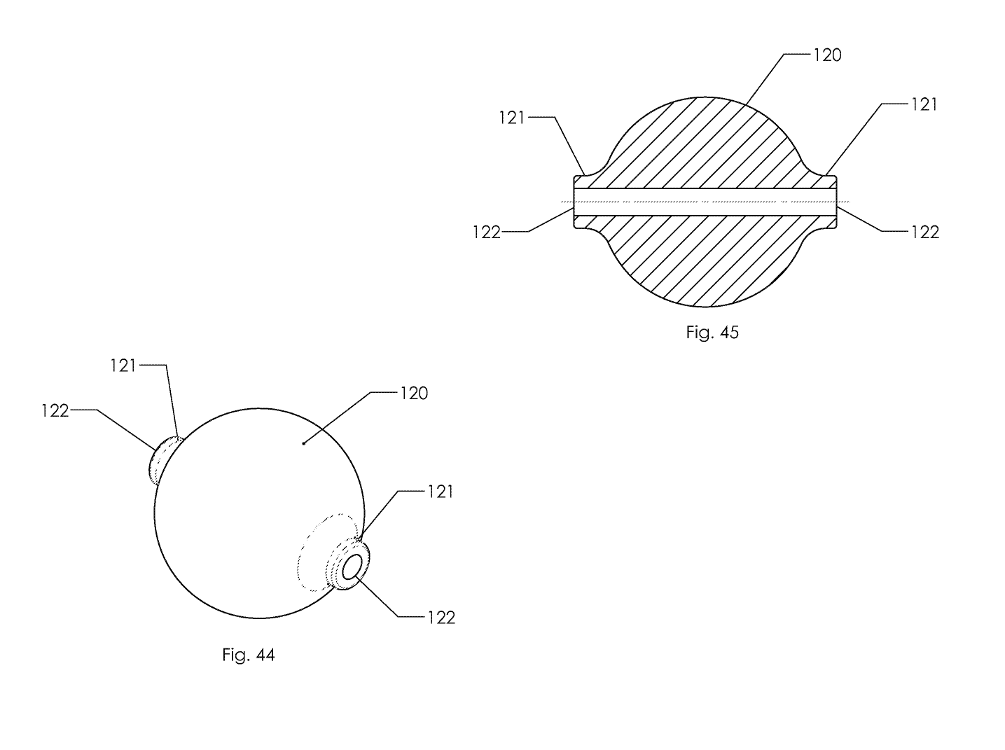

FIG. 44 shows a perspective view a large ball insert 120. The shape of the large ball insert 120 may be generally spheroid. The large ball insert 120 may have two generally cylindrically shaped spacer sections 121, each with an opening 122 to slide over the shaft 104. The spacer sections 121 may help in separating other inserts that may be used with the device 100. FIG. 45 is a cross-sectional view of the large ball insert 120. The large ball insert 120 may have an outer diameter of about 1″ to about 4″, and the spacer section 121 may extend generally about 0.15 to about 0.6″ from the surface of the large ball insert 120.

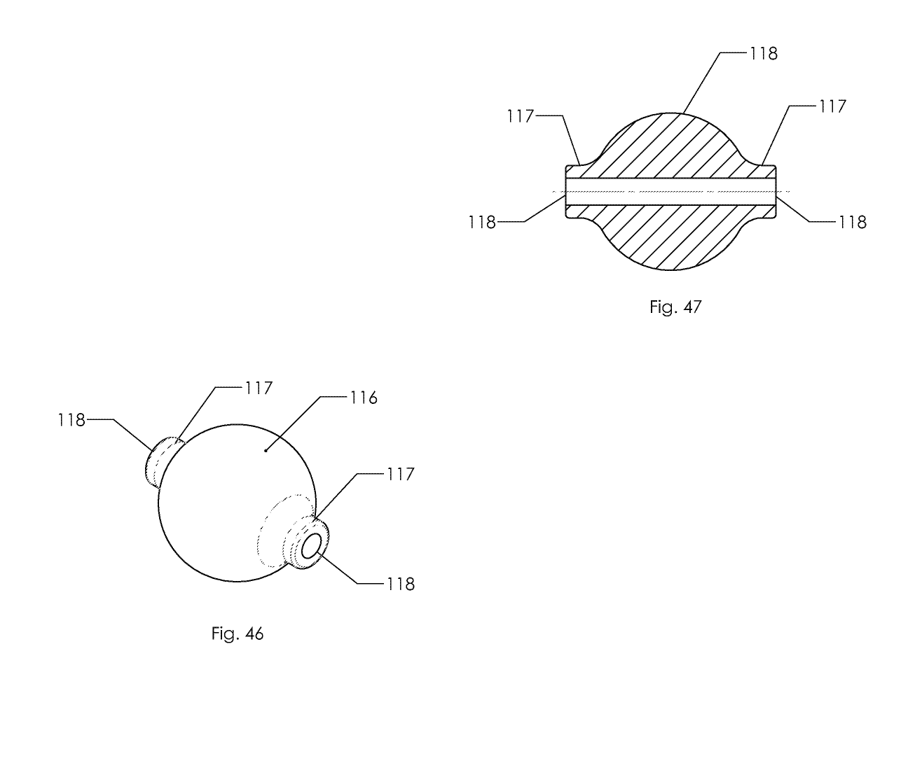

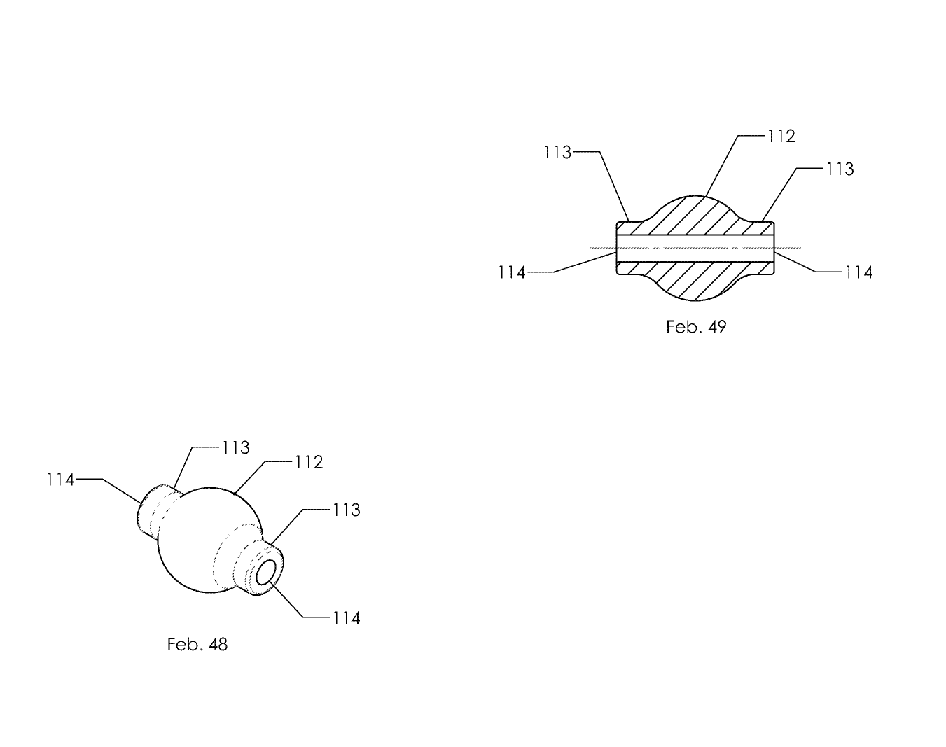

FIG. 46 shows a perspective view a medium ball insert 116. The shape of the medium ball insert 116 may be generally spheroid. The medium ball insert 116 may have two generally cylindrically shaped spacer sections 117, each with an opening 118 to slide over the shaft 104. The spacer sections 117 may help in separating other inserts that may be used with the device 100. FIG. 47 is a cross-sectional view of the medium ball insert 116. The medium ball insert 116 may have an outer diameter of about 0.75″ to about 3″, and the spacer section 117 may extend generally about 0.15 to about 0.6″ from the surface of the medium ball insert 116.

FIG. 48 shows a perspective view a small ball insert 112. The shape of the small ball insert 112 may be generally spheroid. The small ball insert 112 may have two generally cylindrically shaped spacer sections 113, each with an opening 114 to slide over the shaft 104. The spacer sections 1131 may help in separating other inserts that may be used with the device 100. FIG. 49 is a cross-sectional view of the small ball insert 112. The small ball insert 112 may have an outer diameter of about 0.5″ to about 2″, and the spacer section 113 may extend generally about 0.15 to about 0.6″ from the surface of the small ball insert 112.

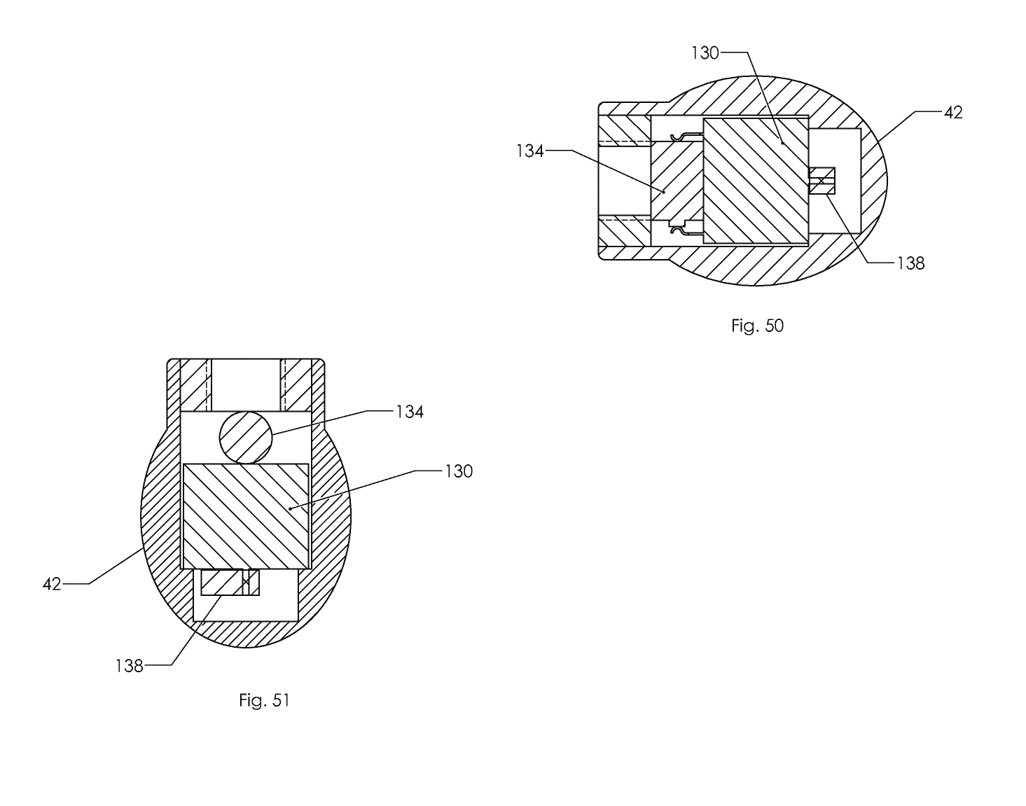

FIG. 50 shows a cross-sectional view of another embodiment of end head 42. In this embodiment, end head 42 has a vibrating motor 130 inside of it to provide a vibration component to the device. A power source 134 such as a battery is also inside the end head 42 and is in communication with the motor 130. An offset weight 138 may be attached to the motor 130 to provide for greater vibration of the head 42. FIG. 51 shows another cross-sectional view of the end head from FIG. 50.

This invention has many advantages. The modular design of the sexual aid allows one to re-configure, re-arrange, or upgrade the device with various inserts at any time. The user can take it apart and slide on various inserts as desired. The end head can be quickly unscrewed from the shaft, and the inserts changed out for various types of stimulations. The device may be used with the human mouth, vagina, and/or anus.

The disclosed sexual aid device may be made out of any suitable material, including but not limited to stainless steel, plastic, silicon, nylon, rubber. The surface of the sexual aid device may be generally smooth, except for those components with bumps, rings, or ridges.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A sexual aid device comprising:
a generally cylindrically shaped shaft
a set of shaft threads on the first end of the shaft;
a first head attached to the second end of the shaft;
a plurality of inserts configured to slide along the shaft and configured to not be able to slide over the first head; and
a second head with a set of internal threads configured to mate with the shaft threads, wherein when the second head is attached to the second end of the shaft, any inserts located on the shaft are held in place on the shaft by the first and second heads.

2. The sexual aid device of claim 1, wherein the first head and second head have a generally smooth surface and spheroidal shape.

3. The sexual aid device of claim 1, wherein the first head and second head have generally the shape of the head of a human penis.

4. The sexual aid device of claim 1,
wherein a first insert is a knobbed insert, the knobbed insert comprising:
a knobbed collar,
a plurality of knobs extending generally orthogonally from the out surface of the knobbed collar;
a hole through the knobbed collar, configured to be slideable over the shaft threads and shaft, but not large enough to be slideable over the first or second head;
wherein a second insert is a helix insert, the helix insert comprising:
a helix collar;
at least one helix extending generally orthogonally from the outer surface of the helix collar;
a hole through the helix collar, configured to be slideable over the shaft threads and shaft, but not large enough to be slideable over the first or second head;
wherein a third insert is a ribbed insert, the ribbed insert comprising:
a ribbed collar;
a plurality of ribs extending generally orthogonally from on the outer surface of the ribbed collar; and
a hole through the ribbed collar, configured to be slideable over the shaft threads and shaft, but not large enough to be slideable over the first or second head.

5. The sexual aid device of claim 1,
wherein a first insert is a French tickler insert, the French tickler insert comprising:
a French tickler collar member;
an extending member extending from the outer surface of the French tickler collar member;
a spherical member attached to the distal end of the extending member;
a plurality of hair like protrusions emanating from the spherical member;
a hole through the French tickler collar, configured to be slideable over the shaft threads and shaft, but not large enough to be slideable over the first or second head.
wherein a second insert is a holey insert, the holey insert comprising:
a holey collar;
a plurality of holes located in the surface of the collar,
a hole through the holey collar, configured to be slideable over the shaft threads and shaft, but not large enough to be slideable over the first or second head;
wherein a third insert is a cube insert, wherein the cube insert comprises:
a generally cube shaped outer surface with rounded corners; and
a hole through the cube insert, configured to be slideable over the shaft threads and shaft, but not large enough to be slideable over the first or second head.

6. The sexual aid device of claim 1,
wherein a first insert is a bump insert, the bump insert comprising:
a bump collar;
a single generally large bump protruding generally orthogonally from no more than one half of the cylinder of the bump collar; and
a hole through the bump collar, configured to be slideable over the shaft threads and shaft, but not large enough to be slideable over the first or second head.

7. The sexual aid device of claim 1,
wherein a first insert is a large ball insert, the large ball insert comprising:
a large spheroid member;
a first generally cylindrically shaped spacer section extending generally orthogonally from the large spheroid member;
a second generally cylindrically shaped spacer section extending generally orthogonally from the large spheroid member and directly opposite of the first generally cylindrically shaped spacer section; and
a hole through the first generally cylindrically shaped spacer section, through the large spheroid member, and through the second generally cylindrically shaped spacer section, configured to be slideable over the shaft threads and shaft, but not large enough to be slideable over the first or second head.

8. The sexual aid device of claim 7,
wherein a second insert is a medium ball insert, the medium ball insert comprising:
a medium spheroid member, with a diameter smaller than the large spheroid member;
a first generally cylindrically shaped spacer section extending generally orthogonally from the medium spheroid member;
a second generally cylindrically shaped spacer section extending generally orthogonally from the medium spheroid member and directly opposite of the first generally cylindrically shaped spacer section;
a hole through the first generally cylindrically shaped spacer section, through the medium spheroid member, and through the second generally cylindrically shaped spacer section, configured to be slideable over the shaft threads and shaft, but not medium enough to be slideable over the first or second head;
wherein a second insert is a small ball insert, the small ball insert comprising:
a small spheroid member, with a diameter smaller than the medium spheroid member;
a first generally cylindrically shaped spacer section extending generally orthogonally from the small spheroid member;
a second generally cylindrically shaped spacer section extending generally orthogonally from the small spheroid member and directly opposite of the first generally cylindrically shaped spacer section; and
a hole through the first generally cylindrically shaped spacer section, through the small spheroid member, and through the second generally cylindrically shaped spacer section, configured to be slideable over the shaft threads and shaft, but not small enough to be slideable over the first or second head.

9. The sexual aid device of claim 1, wherein the first head and second head have an outer diameter of about 3″ to about 1″, and wherein the outer diameter of the shaft may be about 0.5″ to about 2″.

10. The sexual aid device of claim 4, wherein the plurality of knobs extend from the surface of the knobbed collar by about 0.4″ to about 0.1″; wherein the ribs extend from the ribbed collar by about 0.4″ to about 0.1″.

11. The sexual aid device of claim 5, wherein the extending member extends from the French tickler collar member by about 0.4″ to about 0.1″; wherein the hair like protrusions extend about 0.1″ to about 0.6″ from the surface of the spherical member;

12. The sexual aid device of claim 6, wherein the single generally large bump protrudes from the bump collar by about 0.1″ to about 0.6″ from the cylindrical outer surface of the collar.

13. The sexual aid device of claim 1, wherein the first head and second head have an outer diameter of about 0.5″ to about 2″, and wherein the outer diameter of the shaft may be about 0.4″ to about 1″.

14. The sexual aid device of claim 7, wherein the large spheroid member has generally an outer diameter of about 1″ to about 4″, and the first and second generally cylindrically shaped spacer sections extend about 0.15″ to about 0.6″ from the surface of the large spheroid member.

15. The sexual aid device of claim 8, wherein the medium spheroid member has generally an outer diameter of about 0.75″ to about 3″, and the first and second generally cylindrically shaped spacer sections extend about 0.15″ to about 0.6″ from the surface of the medium spheroid member; wherein the small spheroid member has generally an outer diameter of about 0.5″ to about 2″, and the first and second generally cylindrically shaped spacer sections extend about 0.15″ to about 0.6″ from the surface of the small spheroid member.

16. The sexual aid device of claim 1, further comprising:
a vibrating motor inside the first head;
a power supply inside the first head in communication with the vibrating motor;
an offset weight attached to the vibrating motor.
